(19) United States
(12) Patent Application Publication
(10) Pub. No.: US 2012/0099821 A1
(43) Pub. Date: Apr. 26, 2012

(54) FIBER ASSEMBLY ADAPTED FOR OPTICAL TRANSMITTING

(75) Inventors: HSIEN-CHU LIN, New Taipei (TW); CHANG-MAO LI, Kunshan (CN)

(73) Assignee: HON HAI PRECISION INDUSTRY CO., LTD., New Taipei (TW)

(21) Appl. No.: 13/279,249

(22) Filed: Oct. 22, 2011

(30) Foreign Application Priority Data
Oct. 23, 2010 (CN) 201020574627.5

(51) Int. Cl. G02B 6/38

(52) U.S. Cl. 385/74; 385/55

(57) ABSTRACT

A fiber assembly (1000) includes a housing (1) having a base portion (10) and at least one mounting arm (12) extending beyond a front side of the base portion, the base portion defining a plurality passages along a front-to-back direction; a number of fibers (2) respectively extending into the passages for transmitting optical signal; a latching member (4) mounted to the housing, the latching member having at least one latching arm (41) extending along the front-to-back direction and disposed adjacent to the mounting arm; and a dustproof cap (200) disposed in front of the housing, the dustproof cap defining a corresponding slot for receiving the mounting arm and the latching arm.

### BACKGROUND OF THE INVENTION

1. Field of the invention

The present invention relates to a fiber assembly, especially to a fiber assembly adapted for optical transmitting.

2. Description of Related Art

It is well known that optical signal transmitting is faster than electrical signal transmitting. CN Pub. Pat. No. 101345358 published on Jan. 14, 2009 discloses an optical USB connector assembly which has a fiber device added to a USB connector assembly. The fiber device has a number of fibers connected with lenses embedded in the USB connector. Thus, optical signal transmits along a first fiber and is expanded/magnified by a first lens terminated to the first fiber, and then shrunk by a second lens and runs through second fiber of a complementary connector.

However, as the lens (optical mating interface) is exposed outside, and dust may cover thereon and therefore influence optical signal transmitting.

Hence, an improved fiber assembly is required to overcome the problems of the prior art.

### SUMMARY OF THE INVENTION

An object of the present invention is to provide a fiber assembly for reliable optical signal transmitting.

Accordingly, to achieve above-mentioned object, a fiber assembly comprises a fiber connector comprises: a housing having a base portion and at least one mounting arm extending beyond a front side of the base portion, the base portion defining a plurality passages along a front-to-back direction; a number of fibers respectively extending into the passages for transmitting optical signal; a latching member mounted to the housing, the latching member having at least one latching arm extending along the front-to-back direction and disposed adjacent to the mounting arm; and a dustproof cap disposed in front of the housing, the dustproof cap defining a corresponding slot for receiving the mounting arm and the latching arm.

The detailed features of the present invention will be apparent in the detailed description with appropriate reference to the accompanying drawings.

### BRIEF DESCRIPTION OF THE DRAWINGS

FIG. 1 is a perspective view of a fiber assembly in accordance with the present invention;

FIG. 2 is similar to FIG. 1, but viewed from other direction;

FIG. 3 is a partially exploded, perspective view of the fiber assembly;

FIG. 4 is an exploded, perspective view of the fiber assembly; and

FIG. 5 is similar to FIG. 4, but viewed from other aspect.

### DETAILED DESCRIPTION OF THE INVENTION

Reference will now be made in detail to the preferred embodiment of the present invention.

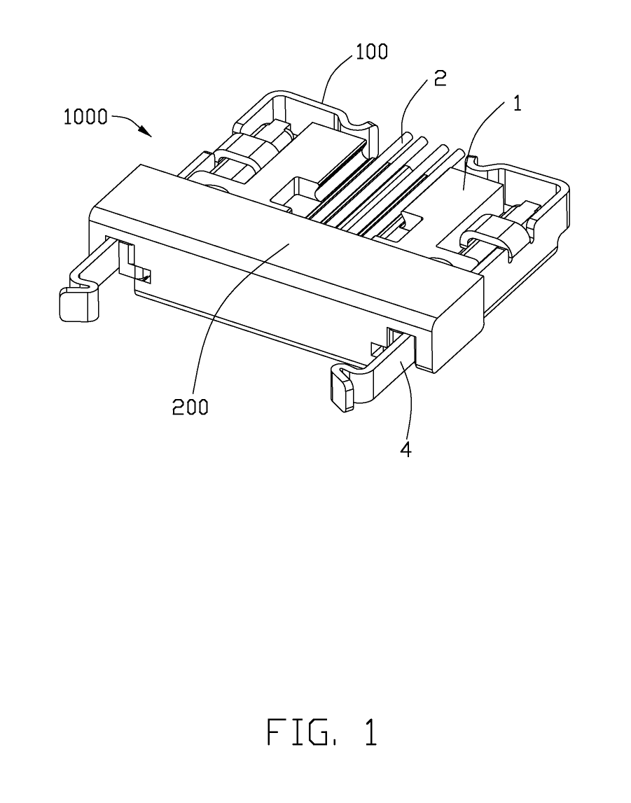

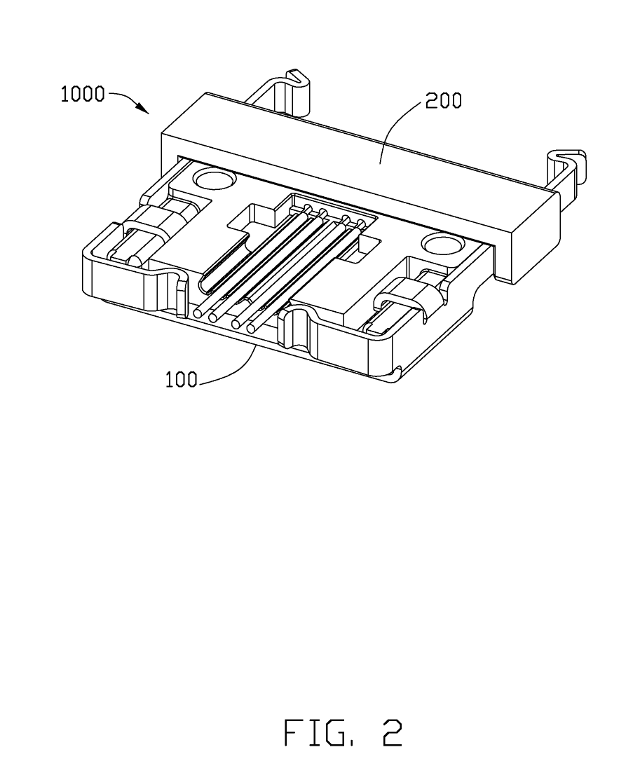

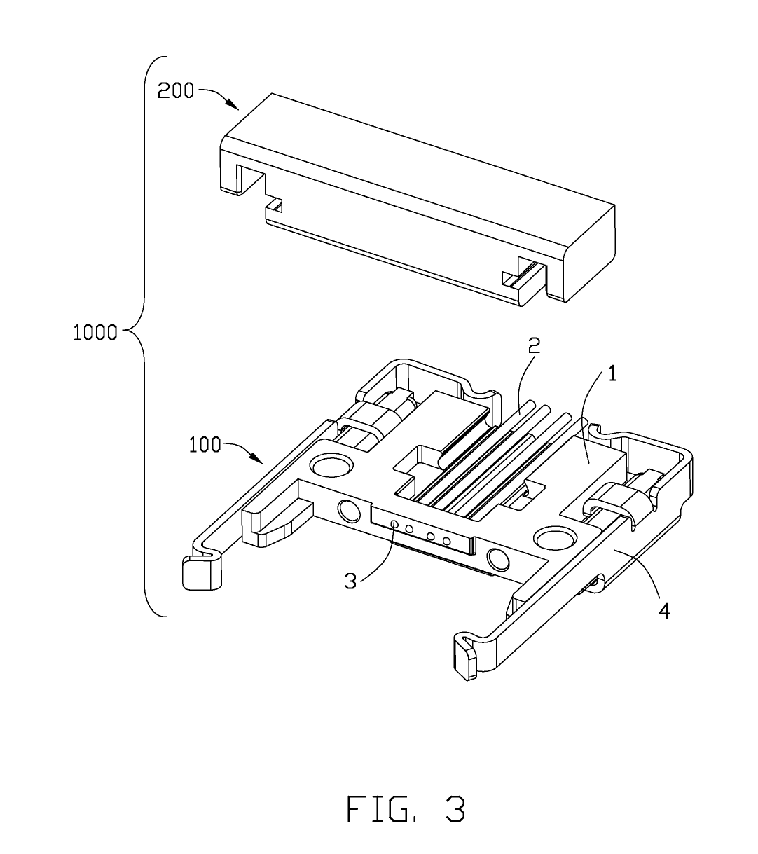

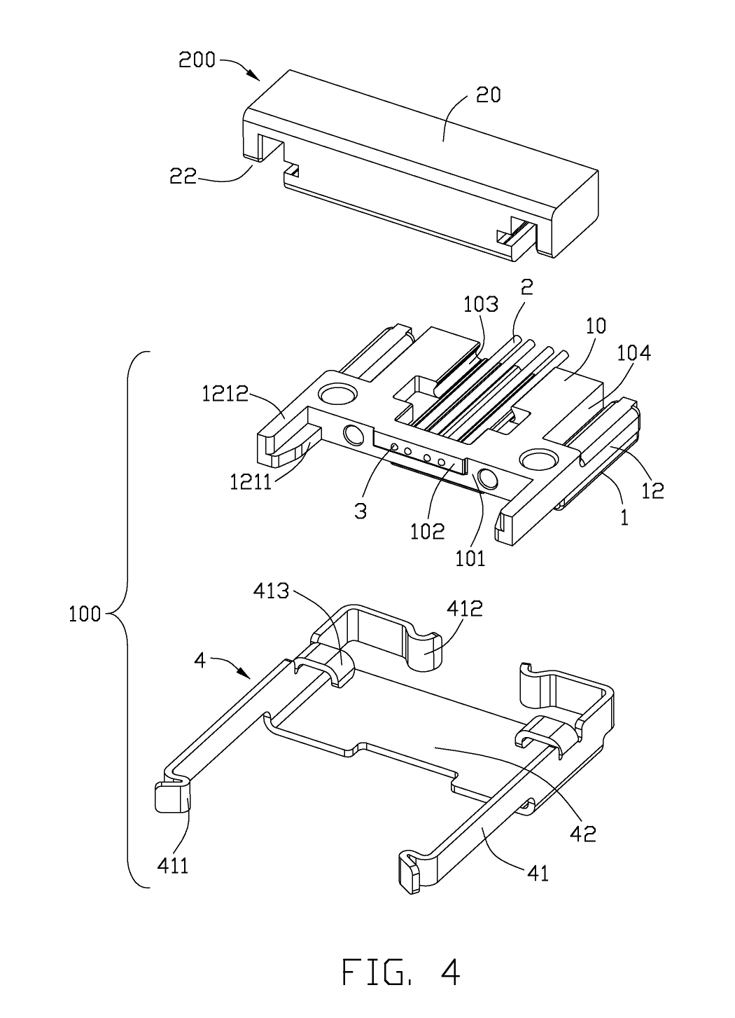

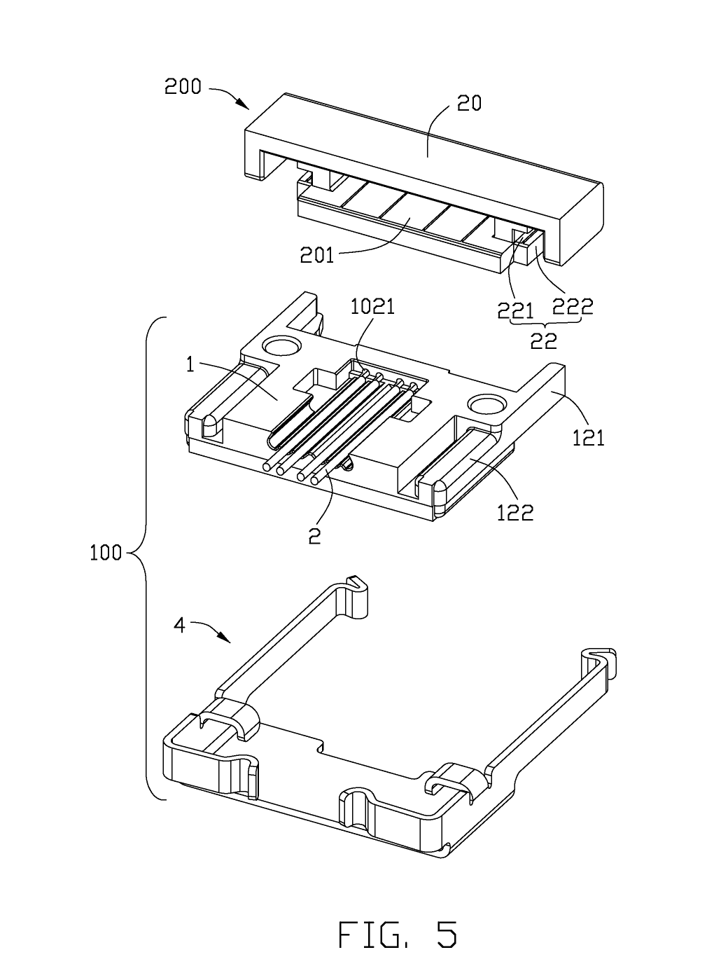

Referring to FIGS. 1-5, a fiber assembly 1000 in accordance with the present invention comprises a fiber connector 100 and a dustproof cap 200. The fiber connector 100 comprises a housing 1, a number of fibers 2, a number of lenses 3 embedded in the housing 1 and optically coupled with the fibers 2 and a latching member 4 mounted to the housing 1.

The housing 1 includes a base portion 10 and two mounting arms 12 arranged at opposite sides of the base portion 10.

The base portion 10 has a front face 101 with a raised mating portion 102 formed on a middle section of the front face 101. There are four passages 1021 extend along a front-to-back direction and through the mating portion 102. The lenses 3 are respectively accommodated in a front section of passages 1021. Thus, the lenses 3 are substantially flushing with a forward side of the mating portion 102 so as to together form a designated optical mating interface. In addition, a depression 103 defined in a middle segment of the base portion 10. The depression 103 is located behind the mating portion 102 and opened upwardly. The fibers 2 are aligned in grooves (not numbered) in the depression 103 and further extend into corresponding passages 1021 to be terminated with the lenses 3. It should be noted that the fibers 2 may be used for transmitting directly, and then the fibers 2 are substantially flushing with the front side of the mating portion 102 too. The fibers 2 are arranged in only one transversal row inside the depression 103.

Each mounting arm 12 includes a first mounting arm 121 and a second mounted arm 122 aligned with each other along the front-to-back direction. The second mounting arm 122 is attached to a lower section of a corresponding lateral side of the base portion 10, with a longitudinal slot (not numbered) therebetween. The first mounting arm 121 is located in front of the base portion 10. The first mounting arm 121 is of L-shaped and has a horizontal part 1211 and a vertical part 1212. The horizontal part 1211 is disposed inside the vertical part 1212. In addition, the horizontal part 1211 defines an inclined guiding face (not numbered).

The latching member 4 is a one-piece structure and includes a U-shaped latching body 42, two latching arms 41 spaced apart from each other along the transversal direction and further respectively connected with the U-shaped latching body 42. The latching arms 41 are located in vertical planes and disposed in front of the latching body 42. The latching body 42 has a planar section (not numbered) and two vertical sections (not numbered) extend upwardly form lateral edges of the planer section. The latching arm 41 extends forwardly from a front edge of the corresponding vertical section of the latching body 42. There is a hook 411 formed at a front end of the latching arm 41 and protruding inwardly therefrom. In addition, there is a substantially L-shaped stopping arm 412 connected with a back edge of the corresponding vertical section of the latching body 42. The stopping arm 412 further has a curved free end projecting forwardly. There also has engaging portion 413 bending inwardly from a top edge the vertical section of the latching body 42 and located above the planar section of the latching body 42.

The latching member 4 is assembled to the housing 1, with the two latching arms 41 respectively located at outside of and adjacent to the first mounting arms 121, the engaging portion 413 gripping the second mounting arm 122, the stopping arm 412 abutting against a back side of the base portion 10, and the latching body 42 shielding the second mounting arms 122 and the bottom side of the base portion 10. Furthermore, the hook 411 is disposed in front of and aligns with the first mounting arm 121.

The dustproof cap 200 has a main portion 20 and two slots 22 respectively located in lateral sections of the main portion 20. The main portion 20 defines a hollow 201. Each slot 22 is of L-shaped and includes a horizontal slot 221 and a vertical slot 222 communicating with each other.

The dustproof cap 200 is mounted to the fiber connector 100, with the mating portion 102 accommodated in the hollow 201, a front section of the latching arm 41 through the corresponding slot 22 and located in front of the dustproof cap 200, the first mounting arm 121 inserted into the corresponding slot 22. The vertical part 1212 and a back section of the latching arm 41 are accommodated in the vertical slot 222, while the horizontal part 1211 is also accommodated in the horizontal slot 221. Thus, the latching member 4 is reliably assembled with the housing 1 with assistance of the dustproof cap 200. So the latching arm 4 is not loosed or deformed in transportation. In addition, the optical mating interface is well protected by the dustproof 200.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A fiber assembly, comprising:
a fiber connector comprises:
a housing having a base portion and at least one mounting arm extending beyond a front side of the base portion, the base portion defining a plurality passages along a front-to-back direction;
a number of fibers respectively extending into the passages for transmitting optical signal;
a latching member mounted to the housing, the latching member having at least one latching arm extending along the front-to-back direction and disposed adjacent to the mounting arm; and
a dustproof cap disposed in front of the housing, the dustproof cap defining a corresponding slot for receiving the mounting arm and the latching arm.

2. The fiber assembly as claimed in claim 1, wherein the mounting arm extends forwardly from a lateral side of the base portion, and the latching arm is located outward of the mounting arm.

3. The fiber assembly as claimed in claim 2, wherein the latching arm is located in a vertical plane.

4. The fiber assembly as claimed in claim 3, wherein there is a hook formed at a front end of the latching arm and protruding inwardly therefrom.

5. The fiber assembly as claimed in claim 1, wherein the mounting arm has a horizontal part and a vertical part.

6. The fiber assembly as claimed in claim 5, wherein the mounting arm is L-shaped.

7. The fiber assembly as claimed in claim 6, wherein the horizontal part is disposed inside the vertical part.

8. The fiber assembly as claimed in claim 6, wherein the slot of the dustproof cap is L-shape.

9. The fiber assembly as claimed in claim 1, wherein there is a raised mating portion formed on a middle section of a front face of the base portion, and the dustproof cap defines a hollow to accommodate the raised mating portion.

10. The fiber assembly as claimed in claim 9, wherein the passages pass through the raised mating portion, and a plurality of lenses are respectively received in the passages and optically coupled with the fibers.

11. The fiber assembly as claimed in claim 9, wherein the lenses are substantially flushing with a front side of the raised mating portion.

12. A fiber assembly, comprising:
a housing having a base portion and two mounting arms extending beyond a front side of the base portion, and the base portion defining a plurality passages along a front-to-back direction;
a number of fibers extending into the passages for transmitting optical signal; and
a latching member mounted to the housing, the latching member including two latching arms spaced apart from each other along the transversal direction and a latching body connected with two latching arms, the two latching arms respectively disposed outside of the two mounting arms for inserting into corresponding slots in a dustproof cap which is located in front of the base portion of the housing.

13. The fiber assembly as claimed in claim 12, wherein the mounting arm includes a first mounting arm and a second mounted arm aligned with each other along the front-to-back direction.

14. The fiber assembly as claimed in claim 13, wherein the first mounting arm is located in front of the base portion, and the second mounting arm is attached to a lower section of a corresponding lateral side of the base portion.

15. The fiber assembly as claimed in claim 14, wherein the latching body has a planar section and two vertical sections extend upwardly form lateral edges of the planer section.

16. The fiber assembly as claimed in claim 15, wherein the latching body shields the second mounting arms and a bottom side of the base portion.

17. The fiber assembly as claimed in claim 16, wherein there is an engaging portion bending inwardly from each vertical section of the latching body, and the engaging portion grips the corresponding second mounting arm.

18. A fiber connector assembly comprising:
a housing defining a front mating port and a rear retention port along a front-to-back direction;
a plurality of optical fibers retained in the rear retention, each of said optical fibers being equipped with a lens in a front end exposed forwardly toward the front mating port;
a pair of resilient latches attached to the housing and located by two lateral sides of the front mating port; and
a dust-proof cover assembled upon the housing and defining a top plate shielding a portion of the front port from an exterior in a vertical direction perpendicular to said front-to-back direction, and a vertical plate shielding said portion from the exterior in the front-to-back direction so as to prevent the lenses from forward exposure to the an exterior; wherein the dust-proof cover includes structures respectively preventing the pair of corresponding latches from incautious outward over-deflection.

19. The fiber connector assembly as claimed in claim 18, wherein the pair of resilient latches are unified via a body plate which covers the rear retention port in the vertical direction.

20. The fiber connector assembly as claimed in claim 19, wherein said pair of resilient latches further include stopping arms extending toward each other in a transverse direction perpendicular to both said front-to-back direction and said vertical direction to form therebetween a space through which the optical fibers extend.
